(19) United States
(12) Patent Application Publication
(10) Pub. No.: US 2010/0055236 A1
(43) Pub. Date: Mar. 4, 2010

(54) Method for Making Beer

(75) Inventors: Dominique Ibarra, Gif-Sur-Yvette (FR); Patrick Boivin, Vandoeuvre Les Nancy Cedex (FR); Mbaka Malanda, Vandoeuvre Les Nancy Cedex (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/514,685

(22) PCT Filed: Nov. 13, 2007
(86) PCT No.: PCT/FR07/52327

§ 371 Date: May 13, 2009

(30) Foreign Application Priority Data
Nov. 14, 2006 (FR) 0654888

(51) Int. Cl. C12C 7/165; C12C 7/04; C12C 7/20

(52) U.S. Cl. 426/16

(57) ABSTRACT

The invention relates to a method for making beer which comprises, in particular, a step of cooking or boiling a wort, and which is characterized in that, in one or more steps which are carried out before said step of cooking or boiling the wort, a reducing gas or mixture of reducing gases is injected into the medium of the step(s) under consideration, so as to lower the oxido-reduction potential of the medium under consideration to a level below what it is when the medium has simply been degassed using a neutral gas.

The invention relates to methods for making beer and other malt-based fermented beverages.

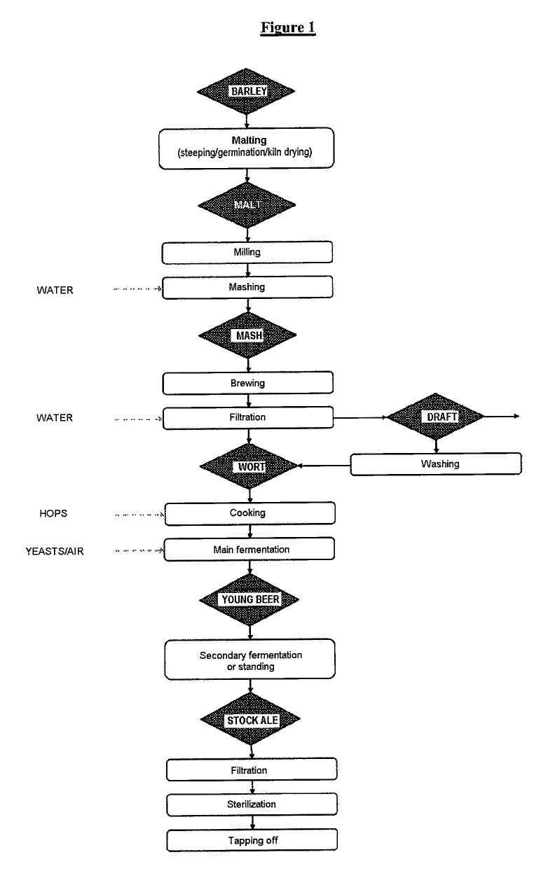

Typically, the brewing process includes the following steps, as represented in FIG. 1 attached hereto:
Malting: The objective of this step is to convert the barley to malt, i.e. to a friable grain, having a more developed flavor and containing a larger amount of enzyme. The barley is first dried and it then matures in a silo. It is subsequently subjected to a cycle of steepings broken by periods of aeration. The grain thus loaded with moisture and oxygen will subsequently germinate (this is germination). Through the action of various enzymes, the storage starch is converted to sugars and the proteins are converted to amino acids, and the cell walls are degraded so as to facilitate subsequent extraction of the flour. Finally, the barley grains are heated and roasted so as to dry them and to give them their color and their flavor (this is kiln drying). The activity of the enzymes is blocked and the malt thus obtained is stabilized.
Milling: The malt is milled in order to make malt flour.
Mashing: The milled malt is mixed with water so as to form the mash.
Brewing: This operation consists in applying a precise heating cycle to the mash with stirring, the objective being to extract therefrom all the possible substances. The temperature steps enable various enzyme reactions to take place: conversion of the proteins to amino acids, decomposition of the starch to fermentable sugars.
Filtration: The mash is filtered in order to separate the wort (liquid containing all the soluble matter dissolved in the water during the brewing) from the draff (insoluble matter). The latter is washed with hot water so as to limit losses.
Cooking: During this step, the wort is subjected to boiling, during which hops, which gives the beer its bitterness, is added. The cooking has multiple objectives: stabilization of the wort by inactivation of the enzymes, sterilization, concentration, coagulation of a part of the proteins, etc. The hops draff and the protein precipitate (“trub”) are removed from the wort, which is subsequently cooled to the temperature at which the fermentation will take place.
Main fermentation: After aeration of the wort, the latter is inoculated with a yeast of the Saccharomyces genus, which will, through fermentation, convert the fermentable sugars to alcohol and to carbon dioxide.
Secondary fermentation or “standing”: This step is carried out at a temperature close to 0° C. for a period which varies from a few days to a few weeks. The young beer will become saturated with carbon dioxide, which will contribute very greatly to its foaming character. It is also during this maturing phase that the beer clarifies and that its flavor becomes keener.
Filtration: The stock ale is filtered so as to remove a large part of the yeasts and also all the remaining matter in suspension (precipitates of polyphenols, proteins, carbohydrates, etc.). Thus, the beer will be clear and biologically stable and colloidal.
Tapping off: Pasteurized, the beer is placed in barrels, bottles, or alternatively in cans.

During some of these steps, it is known that there is a risk of oxidation of the matter treated, thereby leading to an oxidized flavor which is negative for the final product. For example, oxidation of the mash (mixture of crushed malt and water) may occur at the time of brewing, or else oxidation of the wort may occur during the cooking step. During the brewing per se, the literature indicates that approximately 20 mg/l of dissolved oxygen are absorbed and that approximately 76 mg/l are absorbed until the end of cooking of the wort.

Currently, brewers seek to take as many precautions as possible to avoid oxidation, in particular by avoiding the incorporation of a large amount of oxygen throughout the beer-making process, and more particularly during the steps for producing the wort before the fermentation step in order to improve its organoleptic stability during its storage. With this aim, for example, the company Drummond Brewing Co. uses an on-line system of deoxygenation with nitrogen for reducing the oxygen content, of the water used to dilute its concentrated beers, from 6.5/7 ppm to 0.2/0.3 ppm, and also for the filtration operations (Food Processing, 1993, page 129).

However, brewers also focus on the brewing and wort-cooking phases, these being determining steps for the final quality of the beer. Several techniques using gases make it possible to limit wort oxidation phenomena during the brewing.

The first is to work under an atmosphere devoid of oxygen by inerting with a gas, in order to prevent any incorporation of oxygen into the mash. Thus, it has been shown that inerting the vessels with nitrogen during the mashing and the brewing (gas overhead), but also during the crushing of the malt, improves the reducing power of the wort and, consequently, the stability of its flavor. It also makes the wort slightly less colored (see, for example, D. G. Taylor et al., MBAA Technical Quarterly, 1992, vol. 29). The reducing power of a wort is evaluated by the concentration of free-radical-scavenging compounds (such as polyphenols) therein, and is used to predict the stability of the flavor of a beer.

Similarly, T. Desrone et al. (Bios, 1981, vol. 12, No. 4) have shown that carrying out brewing under CO₂ makes it possible to improve the problems posed by excessive dissolution of air in the mash, namely a decrease in the filterability of the wort, and also in the concentration of elements thereof essential for the subsequent fermentation step (sugar, α-amino nitrogen, total nitrogen).

Another technique proposed by the literature for limiting wort oxidation is to degas the ingredients used in the mashing, i.e. the water and the malt grist. Thus, some authors have studied the influence of the presence of oxygen during the brewing on the quality of a wort and of a beer. To do this, malt flour deaerated under vacuum and water through which nitrogen or CO₂ had been bubbled were mixed under an inert atmosphere before the brewing. These treatments, which make it possible to eliminate the oxygen in the brewing, reduced the nonenal potential (indicator of the risk of aging of the future beer) of the filtered must, and also the amount of trans-2-nonenal in the beer after aging, whether said aging was natural (3 months) or else accelerated.

The deoxygenation of the grist can also be carried out with gases. Thus, some authors have proposed a new brewing system which makes it possible to reduce the oxygen consumption during mashing by combining three factors: introduction of the ingredients via the bottom of the brewing vessel, degassing of the water and treatment of the grist with CO₂ so as to flush the oxygen therefrom.

Moreover, the University of Louvain has evaluated the effect of nitrogen bubbling during brewing (Journal of Agricultural and Food Chemistry, 2002, vol. 50, no. 26). The results show that deoxygenation of the water+malt mixture makes it possible to reduce the nonenal potential of a wort after filtration and after cooking.

In order to be even more thorough with regard to the analysis of the prior art in this field, the studies by Sapporo Breweries Ltd., which proposes in document JP 2000004866 a method for producing malt-based alcoholic beverages by which the reducing power is reinforced in order to increase the resistance to oxidation of the final product and therefore to improve the aging of the latter, may also be mentioned.

Firstly, it is suggested to reduce the oxygen concentration in the atmosphere over all or some of the production steps. To do this, it is proposed:
to use deaerated water (deaerated by injection of CO₂, N₂ or else He) as steeping water during the wet crushing of the malt, as wetting water in crushing the malt by wetting the barley grains, or as brewing water,
to inert, using a gas such as CO₂, N₂ or He, the headspace of the devices implanted in all or some of the brewing, fermentation, standing and filtration/conditioning steps.

Secondly, it is suggested to control the stirring speed during the mashing by reducing it to the minimum speed necessary to ensure mixing of the ingredients with the brewing water, so as to optimize the reducing power of the mash.

Prior publications which cite the use of hydrogen may also be mentioned:
the article by F. Spielberger published in Brauwelt in 1991 (No. 23, p. 975) describes a method for treating brewing water with hydrogen, with the aim of reducing as much as possible the dissolved oxygen content of the water.

This deoxygenation treatment requires the use of a metal catalyst in order for it to be possible for the reactions between the hydrogen and the oxygen to take place. So as not to have to subject the hydrogen to authorization according to German legislation, the treatment is carried out in such a way that there is no trace of hydrogen remaining in the product. For this, the hydrogen is added stoichiometrically as a function of the amount of dissolved oxygen in the water to be treated;
document FR 2 077 044 in the name of Brauerei Ind AG concerns improving the storage of beers, by proposing to treat the beer in the form of the final product by bringing the beverage into contact with metals, with, as required, an additional procedure of injecting hydrogen as “oxygen acceptor”. The objective of the document is aimed at stabilizing the final product through two actions: decreasing the oxygen content, and reducing the oxidizing compounds present in the final product;
finally, mention may be made of document FR-1 280 668 (in the name of Francois Moreau-Neret), which describes the use of hydrogen to stabilize fermentable liquids, such as beer, against an undesired microbial proliferation; for this, it injects hydrogen into the final product.

In summary, it may be said that the approach of the techniques used in the existing literature is to flush the dissolved oxygen from the medium under consideration, or else quite simply to put in place, conventionally, an inert gas overhead (“headspace”) above the medium under consideration.

One of the objectives of the present invention is then to propose novel operating conditions for making beer which make it possible in particular to improve the sensory characteristics of the product obtained. In fact, the current techniques for improving the wort flush away the oxygen present in the water or the atmosphere. However, whatever the means used, a small amount of residual oxygen is inevitable. The present invention proposes to go further, i.e. to prepare the wort in a reducing medium, i.e. a medium with an oxidoreduction potential below what it is when the medium has simply been degassed using a neutral gas; preferably, a negative redox potential will be established, using a reducing gas or a mixture of reducing gases. The amount of degradation precursor molecules formed during the preparation of the wort will thus be significantly reduced, which will result in a decrease in the nonenal potential of the wort and better organoleptic stability of the beer during aging thereof.

As will be seen in greater detail below, the present invention proposes to reduce the oxidoreduction potential of at least one of the media involved in the production line before cooking: for example of the mash before brewing, during the brewing per se, or else of the wort after filtration and before cooking, this being by injecting a mixture of reducing gases (for example a mixture of gases comprising hydrogen) into the medium under consideration.

The introduction of a mixture of reducing gases has the advantage of very significantly reducing the oxidoreduction potential of the medium under consideration, in proportions much higher than what would be obtained by simply degassing using a neutral gas as recommended by the prior art, which is the best prevention of any oxidation reaction. Such a mixture of reducing gases, such as an N₂—H₂ mixture, is, moreover, sensorily neutral, nontoxic, and authorized in food products, unlike many chemical reducing agents.

Thus, according to the present invention, unlike the prior art, the objective of which was, for example through removal of the oxygen in the water and the mash by bubbling with CO₂ or else with nitrogen, to remove a substrate of the enzymatic and nonenzymatic oxidation reactions resulting in the reduction of trans-2-nonenal in the beer, the approach of the present invention goes further since it proposes acting on the redox potential by means of an active gas or a mixture of active gases which does not limit itself to deoxygenating the mash. Thus, a reducing gas or a mixture of gases containing a reducing gas, such as hydrogen, is injected at one or more places so as to significantly lower the redox potential of the wort, as described below.

The invention therefore proposes injecting a reducing gas or a mixture of reducing gases in one or more steps of the method for making beer, this being carried out before the step of cooking (or “boiling”) the wort, the injection making it possible to attain a redox potential value of the medium under consideration which is below what would be obtained when the medium has simply been degassed using a neutral gas.

The method according to the invention may, for example, adopt one or more of the following characteristics:
the injection is carried out at the time of mashing, at one or more of the following locations: into the water used for the mashing, or into the mash during and/or after the mixing of the water and of the malt;
the injection is carried out throughout or during part of the brewing step;
the injection is carried out into the water used for the filtration or the washing of the draff, so as to maintain at a low level the redox potential of the wort which goes to the cooking step;
degassing of the malt flour during and/or after the milling is, in addition, carried out;
the injection makes it possible to attain a negative redox potential value for the medium under consideration;
the injected gas is hydrogen or comprises hydrogen;
the injected gas is a mixture of nitrogen and hydrogen;
the injected gas is a mixture of hydrogen and nitrogen containing 4% of hydrogen;
the treatment gas comprises a reducing gas and an additional gas chosen from argon, helium, carbon dioxide and nitrous oxide, and mixtures thereof in any proportions.

It may be specified that the gas/liquid contact can be obtained according to one of the methods well known to those skilled in the art, such as bubbling through the liquid to be treated using a frit, a membrane or a porous material, agitation using a hollow-shaft turbine, use of a hydro-injector, etc.

On-line injections can also be carried out on various parts of pipework of the production plants leading from one station to the other in this plant.

Other characteristics and advantages of the invention will become apparent on reading the description which follows. Forms and embodiments of the invention are given by way of nonlimiting examples.

### EXAMPLE 1

Tepral brewing and filtration tests were carried out with the objective of determining the effect of modifications of the redox potential of the mash, by using gas, on:
the intensity of the oxidation reactions during the brewing, by measuring the nonenal potential of the wort,
the kinetics and other parameters of filtration and of washing of the wort.

To do this, the following procedure was applied for each test: the mash (consisting of 57 g of fine grist and 200 g of water) was subjected to the following temperature increase scheme: 15 minutes at 50° C., increase to 63° C. (1° C./min), 15 minute hold at 63° C., increase to 75° C. (1° C./min), 15 minute hold at 75° C.

The mash was subsequently filtered and the draff was washed with 230 ml of hot water and under a nitrogen pressure. The wort thus obtained was subsequently analyzed. The malt used was a two-row spring malt, of the Pils type.

Six tests were carried out: two control tests, two tests under the nitrogen condition and two tests under the nitrogen/hydrogen (96/4) condition:
The control tests were carried out without modification of the procedure described above.
The nitrogen or nitrogen/hydrogen gas tests were carried out at the following stage: the gas under consideration (N₂ and N₂/H₂ (96/4)) was bubbled into the water which is added to the malt grist so as to produce the mash (“mashing water”).

The bubbling was carried out using a frit for 20 minutes. Moreover, after addition of the malt grist, the headspace of the vessel containing the grist and the water was swept with the same gas throughout the brewing, in order to prevent any reincorporation of oxygen into the mash.

The redox potential values (Eh) of the water thus gassed were measured with a Mettler Toledo probe. Similarly, the redox potential values of the mashes derived from the mixing of this water with the malt were recorded continuously throughout the brewing. The redox potential values thus measured were related back to pH 7 (by means of formulae well known to those skilled in the art, such as the Leistner and Mirna equation which makes it possible to relate the Eh of a medium of pH=x back to its value at pH 7).

The average redox potential values of the water used and those of the mashes obtained are given in table 1.

### a) Measurement of the Nonenal Potential

The nonenal potential of the worts obtained was measured in the following way: after conversion of the hydroperoxides of the polyunsaturated fatty acids present into trans-2-nonenal by heating under an inert atmosphere, the trans-2-nonenal was extracted with carbon disulfide and quantified by gas chromatography with detection by mass spectrometry.

The average nonenal potential values obtained are given in table 2.

These results show that the use of the gases according to the invention makes it possible to reduce the nonenal potential of the wort derived from the brewing. Specifically, it is observed that the nonenal potential of the control is greater than that obtained under the nitrogen condition, which is itself greater than that obtained under the nitrogen/hydrogen condition. Trans-2-nonenal is responsible for the appearance of the “cardboard” taste during aging of the beer. It has a very low perception threshold (0.1 ppb). This molecule is considered by those skilled in the art to be the compound that indicates the intensity of degradation of the quality of the beer due to oxidation reactions. The nitrogen/hydrogen condition therefore made it possible to halve the nonenal potential value of the wort. This lowering of the oxidizing potential is beneficial to the sensory stability of the beer.

### b) Measurement of the Free Amino Nitrogen

The method for measuring the free amino nitrogen consists in heating the wort in the presence of ninhydrin and reading the absorbance of the sample at 570 nm relative to a “blank” sample of distilled water.

The average free amino nitrogen values obtained are given in table 3.

A slight increase in the free amino nitrogen of the wort is observed with the nitrogen and nitrogen/hydrogen conditions relative to the control. The determination of the free amino nitrogen of the wort gives an estimation of the amino acids and of the terminal alpha-amino nitrogen of the peptides and proteins. The nitrogen and nitrogen/hydrogen conditions therefore slightly increase the amount of substrate available for the yeast growth during the subsequent fermentation step.

### c) Other Parameters Measured

The other parameters measured were filtration and washing characteristics: filtration rate, washing speed, brewing yield.

No difference was observed for these parameters. The modification of the redox potential of the medium according to the invention therefore made it possible to improve the quality of the wort (lowering of the nonenal potential, slight increase in free amino nitrogen) without, however, impairing the economic parameters, namely the filtration rate and the washing speed, and also the yield.

### EXAMPLE 2

A lager with an original gravity of 12° plato was produced on a semi-industrial scale of 20 hliters. Nine brewings were carried out using one and the same malt.

Three brewings were carried out for each of the following three treatments: three control mash tubs (brewing under the normal conditions), three mash tubs with reduction of the redox potential using nitrogen and three mash tubs with reduction of the redox potential using a mixture of nitrogen and hydrogen (96/4).

For this, the gas is introduced at various steps (using plugs from Federal Mogul):
bubbling into the water used for producing the mash, for the filtration of the mash and for washing the draff,
bubbling into the mash before the brewing and before the filtration,
inerting various plants used for the brewing, filtration and washing, and boiling steps.

The beer-making steps were the following: production of the mash (300 kg of malt+950 kg of water+CaCl₂), brewing, filtration of the mash and washing of the draff, boiling, inoculation, fermentation, standing, filtration and stabilization, bottling, pasteurization.

Just as in example 1, the redox potential values (Eh) were measured with a Mettler Toledo probe and related back to pH 7. The pH values were also recorded with a Mettler Toledo probe. The dissolved oxygen values were, for their part, measured with an HQ 30d Flexi analyzer (Hach).

### a) Redox Potential and Dissolved Oxygen

The average redox potential and dissolved oxygen values obtained on the mash before brewing are given in tables 4 and 5.

It is observed that the redox potential values do not decrease very much during the treatment with nitrogen, which is limited to flushing out the oxygen. On the other hand, treatment with a nitrogen/hydrogen mixture considerably lowers the redox potential compared to the control and to the treatment with nitrogen alone.

The dissolved oxygen values are equivalent among the three conditions. They are relatively low in the three cases, doubtless due to the temperature of the mash, which is at 45° C.

These results show that it is possible to have radically different redox potentials while at the same time having the same level of residual dissolved oxygen.

### b) Measurement of the Nonenal Potential

The average nonenal potential values obtained are given in table 6.

These results show first of all that the gas treatment, whatever it is, makes it possible to reduce the nonenal potential of the wort at the end of brewing and of filtration (before boiling). At this stage, the nitrogen/hydrogen condition had an effect that was at least equivalent to that of nitrogen on the nonenal potential (it should be pointed out, moreover, that one of the values obtained with nitrogen/hydrogen was so low that it could not be quantified).

On the other hand, at the end of boiling, the nonenal potential obtained with the reducing treatment with nitrogen/hydrogen is very much lower than those obtained with the “control” and “nitrogen alone” conditions.

These results therefore show that a reducing treatment with nitrogen/hydrogen makes it possible to significantly decrease the oxidation reactions which take place during the production of the worts intended to be fermented. Since this effect is observed on worts having the same initial dissolved oxygen concentration, it is therefore clear that it is indeed the reducing property of the gas which has been the determining factor. It was not in this case an effect due to a simple deoxygenation.

Furthermore, just as in example 1, the modification of the redox potential of the medium according to the invention made it possible to improve the quality of the wort without, however, impairing the economic parameters for production of the beer.

TABLE 1
Average values of the redox potentials obtained

| | Control | N₂ condition | N₂/H₂ condition |
|---|---|---|---|
| Eh₇ of the water | +444 mV | +245 mV | −530 mV |
| used for the | | | |
| mashing | | | |
| Eh₇ of the mash, | +406 mV | +191 mV | −366 mV |
| 2 min after | | | |
| mashing | | | |

TABLE 2
Average nonenal potential values of the worts

| | Control | N₂ condition | N₂/H₂ condition |
|---|---|---|---|
| Average nonenal | 3.4 μg/L | 2.4 μg/L | 1.7 μg/L |
| potential | | | |

TABLE 3
Average values of the free amino nitrogen content of the worts

| | Control | N₂ condition | N₂/H₂ condition |
|---|---|---|---|
| Free amino | 174 mg/L | 185 mg/L | 188 mg/L |
| nitrogen | | | |

TABLE 4
Average values of the redox potentials obtained

| | Control | N₂ condition | N₂/H₂ condition |
|---|---|---|---|
| Eh₇ of the mash | +81 mV | +18 mV | −403 mV |
| before brewing | | | |

TABLE 5
Average values of the dissolved oxygen contents

| | Control | N₂ condition | N₂/H₂ condition |
|---|---|---|---|
| O₂ of the mash | 0.6 ppm | 0.4 ppm | 0.6 ppm |
| before brewing | | | |
| (45° C.) | | | |

TABLE 6
Average values of the nonenal potentials

| | Control | N₂ condition | N₂/H₂ condition |
|---|---|---|---|
| Nonenal | 7 μg/L | 4.2 μg/L | <LQ*, 4.1 and |
| potential of the | | | 4.2 μg/L |
| wort before | | | |
| boiling | | | |
| Nonenal | 6.8 μg/L | 7 μg/L | 4.9 μg/L |
| potential of the | | | |
| wort at the end | | | |
| of boiling | | | |

*The indication “<LQ” signifies that the value is below the limit of quantification of the method of analysis.

1-10. (canceled)

11. A method for making beer comprising introduction of a reducing gas into a medium used in one or more steps prior to the step of cooking or boiling a wort, thereby lowering an oxidoreduction potential of the medium to a level below an oxidoreduction potential of the medium degassed using a neutral gas.

12. The method of claim 11, wherein introduction of the reducing gas lowers the oxidoreduction potential of the medium to a negative number.

13. The method of claim 11, further comprising a mashing step in which water is mixed with a milled malt to produce a mash prior to the step of cooking or boiling the wort, wherein the reducing gas is introduced into the medium selected from the group consisting of:
a) water;
b) the mash during the mixing of water and milled malt;
c) the mash after the mixing of water and milled malt; and
d) combinations thereof.

14. The method of claim 11, further comprising a brewing step in which a mash is heated and stirred prior to the step of cooking or boiling the wort, wherein the reducing gas is introduced into the mash in the brewing step.

15. The method of claim 14, wherein the reducing gas is introduced into the mash throughout the entire brewing step.

16. The method of claim 11, further comprising the steps of filtering and washing a draff prior to the step of cooking or boiling the wort, wherein the reducing gas is introduced to water used for filtering or for washing the draff.

17. The method of claim 11, further comprising introducing the reducing gas to a malt flour during and/or after milling.

18. The method of claim 11, wherein the reducing gas comprises hydrogen.

19. The method of claim 11, wherein the reducing gas comprises a mixture of nitrogen and hydrogen.

20. The method of claim 19, wherein the reducing gas comprises 4% hydrogen.

21. The method of claim 11, wherein the reducing gas comprises a mixture of hydrogen and an additional gas selected from the group consisting of argon, helium, carbon dioxide, nitrous oxide, and mixtures thereof.
